(19) United States
(12) Patent Application Publication
(10) Pub. No.: US 2021/0065213 A1
(43) Pub. Date: Mar. 4, 2021

(54) Analysis of Customer Interaction Data

(71) Applicant: Wells Fargo Bank, N.A., San Francisco, CA (US)

(72) Inventors: Evelyn Ujanen, San Francisco, CA (US); Daniel Dixon, San Francisco, CA (US); Cigdem Gencer, San Francisco, CA (US)

(21) Appl. No.: 14/982,658

(22) Filed: Dec. 29, 2015

(51) Int. Cl. G06Q 30/02; G06Q 30/00

(52) U.S. Cl. CPC G06Q 30/0201; G06Q 30/0202; G06Q 30/016

(57) ABSTRACT

A method for analyzing interactions of a customer with an organization includes obtaining data regarding interactions of the customer with the organization. The data is obtained from a plurality of sources and aggregated into a plurality of categories. Using a data model, a value for aggregated data in a category at a time period is predicted. An actual value for the aggregated data for the category at the time period is obtained. A determination is made as to whether a difference between the value predicted for the aggregated data for the category and the actual value for the aggregated data for the category exceeds a threshold. When the difference between the value predicted for the aggregated data for the category and the actual value for the aggregated data for the category exceeds the threshold, one or more actions is taken regarding the customer.

### BACKGROUND

In a competitive environment, organizations have a strong interest in attracting new customers and keeping customers that they already have. It can be advantageous to the business organizations to keep customers happy so that the customers do not leave the organization.

Sometimes customers are unhappy with the organization and can manifest their unhappiness through the ways that they interact with the organization. However, organizations are not always able to identify customer interactions that may indicate a level of customer dissatisfaction.

### SUMMARY

Embodiments of the disclosure are directed to a method for analyzing interactions of a customer with an organization, the method comprising: obtaining data regarding interactions of the customer with the organization, the data being obtained from a plurality of sources; aggregating the data obtained into a plurality of categories; using a data model, predicting a value for aggregated data in a first category at a first time period; obtaining an actual value for the aggregated data for the first category at the first time period; determining whether a difference between the value predicted for the aggregated data for the first category and the actual value for the aggregated data for the first category exceeds a first threshold; and when the difference between the value predicted for the aggregated data for the first category and the actual value for the aggregated data for the first category exceeds the first threshold, taking one or more actions regarding the customer.

In another aspect, an electronic computing device comprising: a processing unit; and system memory, the system memory including instructions which, when executed by the processing unit, cause the electronic computing device to: obtain data regarding interactions of a customer household with a financial institution for a customer of the financial institution, the data being obtained from a plurality of sources; aggregate the data obtained into a plurality of categories; using a data model, predict an aggregated data value in a first category at a first time period; obtain an actual value for aggregated data for the first category at the first time period; determine whether a difference between the predicted aggregated data value for the first category and the actual value for the aggregated data for the first category exceeds a first threshold; and when the difference between the predicted aggregated data value for the first category and the actual value for the aggregated data for the first category exceeds the first threshold, take one or more actions regarding the customer.

In yet another aspect, an electronic computing device includes a processing unit; and system memory, the system memory including instructions which, when executed by the processing unit, cause the electronic computing device to: obtain data regarding interactions of a customer household with a financial institution for a customer of the financial institution, the data being obtained from a plurality of sources, the data regarding the customer household encompassing a multi-year period; aggregate the data obtained into a plurality of categories, the plurality of categories including one or more of deposits, relationship maintenance, in-person withdrawals, withdrawals other than in-person, in-person activity and remote activity; using a data model, predict a value for aggregated data in a first category at a first time period, the data model using one or more of a trend, a cyclicality and a seasonality of the data that is aggregated to predict the aggregated data in the first category; obtain an actual value for the aggregated data for the first category at the first time period; determine whether a difference between the value predicted for the aggregated data for the first category and the actual value for the aggregated data for the first category exceeds a first threshold, the first threshold being a percentage; and when the difference between the value predicted for the aggregated data for the first category and the actual value for the aggregated data for the first category exceeds the first threshold, take one or more actions regarding the customer; using the data model, predict a value for aggregated data for one or more additional categories at the first time period; obtain the actual value for aggregated data for the one or more additional categories at the first time period; determine whether a difference between the value predicted for the aggregated data for the one or more additional categories and the actual value for the aggregated data for the one or more additional categories exceeds one or more additional thresholds; and when the difference between the value predicted for the aggregated data for the one or more additional categories and the actual value for the aggregated data for the first category exceeds the one or more additional thresholds, take one or more actions regarding the customer, wherein the one or more additional thresholds can be different for each of the one or more additional categories and different from the first threshold.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports customer patterning.

FIG. 2 shows example modules of the customer interaction processing module of FIG. 1.

FIG. 3 shows an example graph of customer inquiries over a time period.

FIG. 4 a table of component values for the unobserved components model for the graph of FIG. 3.

FIG. 5 shows a flowchart of an example method for analyzing customer interaction data at a financial institution.

FIG. 6 shows example physical components of the server computer of FIG. 1.

### DETAILED DESCRIPTION

The present disclosure is directed to systems and methods that analyze customer interactions with an organization and attempt to identify behavioral patterns in the customer interactions. The behavioral patterns can be matched against customer behaviors that can indicate or predict customer issues with the organization. For example, when the behavior patterns detect customer dissatisfaction with the organization, if the organization is a financial institution, a prediction can be made that there can be an imminent reduction in the customer's deposit balance at the financial institution.

The behavioral patterns can also indicate when a customer's normal behavior has changed. Examples of changes in a customer's normal behavior can be making large deposits or withdrawals from a financial account, closing an account or making a formal complaint against the business organization. Other examples of changes in a customer's normal behavior can be a customer entering a store or calling after a pattern of managing accounts purely online and a customer repeatedly withdrawing their daily limit from an automated teller machine (ATM) after a pattern of biweekly withdrawals. Additional examples of changes in a customer's normal behavior are possible.

In the examples provided below, interactions are described between a customer and a financial organization such as a bank. However, the systems and methods described herein are also applicable to other types of organizations.

Customer interactions with the financial institution can include a wide variety of activities. Example customer interactions with the financial institution can include making deposits and withdrawals in person, for example at a bank branch office, making deposits and withdrawals online, using an automated teller machine (ATM), accessing a website of the financial institution, visiting an office of the financial institution and talking in person to an investment advisor, telephoning a personal banker, applying for a loan, opening up an individual retirement account (IRA), consolidating financial accounts, closing a checking account, etc. Other types of customer interactions with the financial institution are possible.

Each time a customer has an electronic interaction with the financial institution, a data record can be made of the interaction. In addition, each time the customer has an in-person interaction with a financial institution, a data record can also be made of the interaction.

Because a customer can have a large number of different customer interactions with the financial institution, using the systems and methods, the customer interactions are aggregated into a smaller number of categories. In an example implementation, six categories of customer interactions are used—deposits, relationship maintenance, in-person withdrawals, remote withdrawals, in-person activity and remote activity. In this disclosure, the systems and methods are described with regard to these six categories. However, in other implementations more, fewer or different categories can be used. In this implementation, customer data is aggregated on a per household basis, including customer interactions for all family members in a household.

In this disclosure, deposits refer to monetary deposits at the financial institution, in-person withdrawals refers to monetary withdrawals made at the financial institution, remote withdrawals refer to electronic withdrawals made online or at an ATM, in-person activity refers to inquiries or meetings with employees of the financial institution that are held at the financial institution and remote activity refers to on-line inquiries or telephone calls made by the customer to the financial institution from outside the financial institution. In this disclosure, relationship maintenance refers to customer updates or requests for information about the customer's accounts, for example balance inquiries or personal information modifications, document requests, etc.

For each customer interaction that is documented, each time the customer has the interaction, a total of customer interactions for the aggregated category is updated. For example, for each customer deposit, the aggregated count of customer deposits is updated and for each customer inquiry about the customer's account balance or each modification to the customer's profile at the financial institution, the aggregated count of relationship management for the customer is updated. In one example implementation, customer interaction data is aggregated on a per household basis and on a monthly basis.

Using the systems and methods customer interaction data for each of the categories is aggregated over a multi-year period of time, for example over a three year period, although other time periods can be used. The aggregated data accumulated over this time period is then applied to a data model. The data model can be used to predict values for the aggregated data for additional time periods in the future. As discussed in more detail later herein, an analysis of differences between predicted values of aggregated data for the additional time periods in the future and actual aggregated data for the additional time periods can identify changes in customer behavior that can indicate an issue with the customer at the financial institution.

Before the aggregated data for a customer household is applied to the data model, the aggregated data is checked to ensure that aggregated data totals during the multi-year period are stable. A check can be made, for example, to verify that the aggregated data totals do not deviate by a certain percentage, for example 20 percent, between the start of the multi-year period and each year within the multi-year period. A check for stability can also be made at intervals shorter than one year. When a determination is made that the aggregated data for the customer household is stable, the aggregated data can be used with the data model. When the aggregated data during the multi-year period is stable, any changes in aggregated data totals after the end of the multi-year period can be more likely attributed to changes in customer household behavior.

In the present disclosure, the data model used is the unobserved components data model. As discussed in more detail later herein, the unobserved components model can identify a trend for the aggregated data over time and can also identify an amplitude and frequency of any cyclicality in the aggregated data, any seasonality in the aggregated data and an additional factor for dampening in the aggregated data. The unobserved components model can predict future values for the aggregated data. When actual values for the aggregated data are compared against predicted values, any deviations between the predicted values and the actual values that are greater than a threshold, for example 20 percent, can be used to identify possible customer issues at the financial institution. Although the unobserved components model is used in the implementation, in other implementations other data models can be used. Examples of other data models that can be used include an autoregressive integrated moving average (ARIMA) data model and an adaptive thresholding data model.

After the aggregated data is analyzed, when a determination is made that the customer's behavior is deviating from normal, the systems and method can identify the customer for follow up with an employee of the financial organization. For example, the employee can contact the customer and arrange a meeting to determine whether there is anything the financial organization can do to help the customer.

The systems and method can also be used to identify customers who may take an action detrimental to the financial organization before the customer actually takes the action. For example, if a certain aggregated data pattern can be found for a customer before a customer lodges a complaint, a determination that another customer has this same aggregated data pattern can identify the customer as someone to whom a proactive action, such as contacting the customer, can be taken before the customer lodges the complaint.

The systems and methods can also be used to validate a methodology used to identify customers who may have issues with the financial organization and to self-correct the methodology when appropriate. For example, thresholds can be modified to properly identify customers with issues. As another example, customers who have been identified as being flagged for follow-up can be tracked over time to see whether the customer actually did have the issues predicted or took any actions predicted, such as closing an account. Corrections to the methodology can be made based on an evaluation of future customer behavior.

As discussed earlier herein, an analysis of customer interactions can be used to explain future diminishment of customer satisfaction at the financial institution. Some factors that can help predict future diminishment of customer satisfaction can include a customer dropping bill pay, a household dropping direct deposit, an increased number or amount of withdrawals at the financial institution, a change in the financial needs of the customer (typically, the fewer the financial needs, the more likely chance of future customer dissatisfaction, removing an account, requesting a fee change, etc. Some factors that can help predict customer satisfaction at the financial institution can include check orders/reorders, financial planning, adding accounts, enrollment in online banking, enrollment in mobile banking and applying for a credit card. Other factors that predict customer dissatisfaction and satisfaction are possible.

As stated earlier herein, the systems and methods in this disclosure are directed to customer interactions at a financial institution. However, as also stated earlier herein, the systems and methods can be used in areas other than a financial institution. Other examples of how the systems and method can be used include identifying interest in products such as retirement, educational IRAs, money market funds and investment based on increased traffic to different areas on the Internet. Another example includes understanding how interaction preferences differ by customer segments to help tailor a customer experience. Additional examples are possible.

The systems and methods disclosed herein are directed to a computer technology that solves an existing problem in proactively addressing customer issues before a customer takes a negative action, such as closing an account at a financial institution. The use of a data model to proactively identify customers who may have issues with the financial institution can improve a speed of an analysis of customer interaction data. Instead of having an employee of the financial institution access customer records in a haphazard way, wasting computer processing time, the use of the data model can quickly and automatically identify customers who may have issues with the financial institution, thereby improving the efficiency of computer systems at the financial institution.

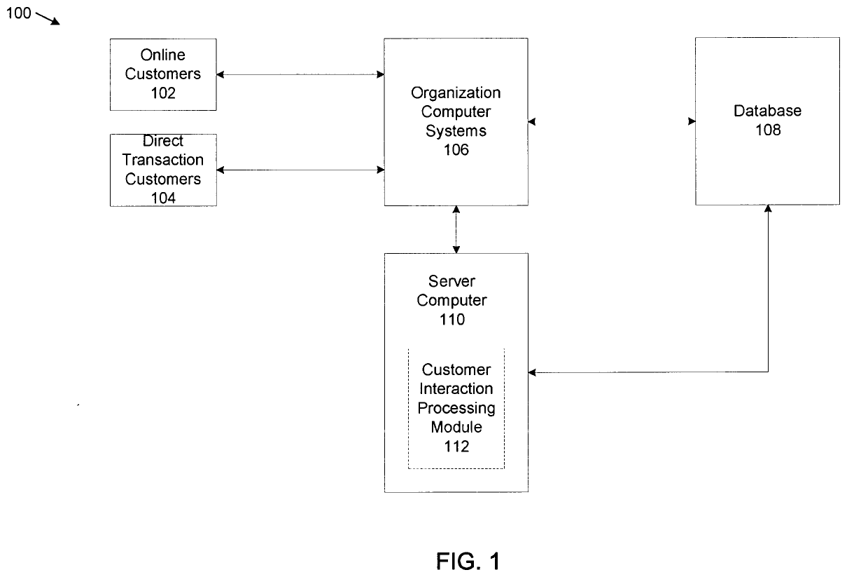

FIG. 1 shows an example system 100 that supports analyzing customer interaction data at a financial institution and determining patterns in customer behavior at the financial institution. System 100 includes online customers 102, direct transaction customers 104, organization computer systems 106, database 108 and server computer 110. Server computer 110 includes a customer interaction processing module 112.

The example online customers 102 include customers of an organization that access the organization computer systems 106 using a desktop computer, laptop computer, tablet computer, mobile computing device or ATM across a network such as the Internet or an organization specific network. For the example system 100, the organization is a financial institution such as a bank. However, in other examples the organization can be any organization that has customers or clients. Examples of online customers 102 can include customers conducting online banking transactions via a client computer or a smartphone and accessing a website of the financial institution. Other examples of online customers 102 are possible.

The example direct transaction customers 104 include customers of the financial institution that interface with the financial institution in-person, such as by visiting an office of the financial institution and communicating with an employee of the financial institution. Examples of direct transaction customers 104 can include depositing funds into a bank account at a teller window, meeting with a financial institution employee to apply for a mortgage or discussing an investment strategy in person with an investment advisor. Other examples of direct transaction customers 104 are possible.

The example organization computer systems 106 include computing systems of the financial institution, comprising one or more desktop computers, server computers, server computer farms or other similar computing systems. The organization computer systems 106 can be located at a plurality of geographical locations and are each connected to a network such as the Internet or a corporate Intranet. The organization computer systems 106 include computing systems that can interface and provide access to the online customers 102 and to employees of the financial institution. For example, when a direct transaction customer 104 withdraws money from his bank account at a teller's window, the teller can access one of the organization computer systems 106 from a desktop computer and send data regarding the transaction to another of the organization computer systems 106, for example a server computer.

The example database 108 is a database used by the financial institution comprising one or more physical databases than can be located at a plurality of geographical locations. The database 108 can store records of online and in-person customer interactions with the financial institution. The database 108 can be accessed from one or more of the organization computer systems 106 or from server computer 110.

The example server computer 110 is a server computer of the financial organization that can process records of customer interactions with the financial institution and determine patterns in the customer interactions, as discussed in more detail later herein. In some examples, as shown in FIG. 1, server computer 110 does not interact directly with online customers 102 or direct transaction customers 104 but instead is dedicated to processing the records of the customer interactions. In other implementations, server computer 110 can both interface with customers and also process records of the customer interactions. As shown in FIG. 1, server computer 110 can access records of customer interactions from both organization computer systems 106 and from database 108.

The example customer interaction processing module 112 receives customer interaction data from the organization computer systems 106 and from database 108 and analyzes the customer interaction data to determine patterns in the data and to determine whether the patterns in the data indicate a possible issue with the customer's relationship with the financial institution. Customer interaction data is received from a plurality of categories and aggregated into a small number of categories. The aggregated data is then applied to a data model, in this example the unobserved components model, which extracts components of the aggregated data. A pattern of customer interactions can be obtained from analyzing outputs of the data model over a time period. Deviations from a normal data pattern can indicate a possible issue with the customer's relationship with the financial institution. The customer interaction processing module 112 is discussed in greater detail in the following paragraphs herein.

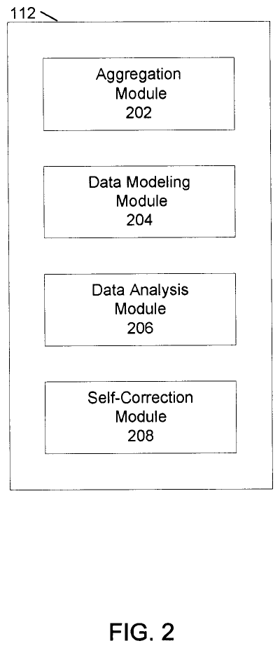

FIG. 2 shows example modules of the customer interaction processing module 112. The customer interaction processing module 112 includes an aggregation module 202, a data modeling module 204, a data analysis module 206, and a self-correction module 208. Other modules are possible.

The example aggregation module 202 aggregates a plurality of customer interaction data into a smaller number of aggregated categories. Interaction data can include many types, in some implementations hundreds of types. For example the organization computer systems 106 can include records for a customer logging onto an organization website and a record of each webpage accessed on the webpage for the customer. As another example, the organization computer systems 106 can include records for each time the customer requests information about an account and records for specific information requested and received during each inquiry. When customer interaction records can include hundreds of categories, the customer interaction records can be difficult to analyze. For this reason, aggregated categories are used. For the example customer interaction processing module 112, six aggregated categories are used—deposits, relationship maintenance, in-person withdrawals, remote withdrawals, in-person activity and remote activity, as described earlier herein. In other implementations more, fewer or different aggregated categories can be used.

When viewing data points of the aggregated data over time, a line representing a linear regression of the data points can be drawn and a slope can be calculated for the line representing the linear regression. However, the aggregated data can include components that can have an impact on an accurate interpretation of the slope of the line. For example, the aggregated data can be affected by seasonal changes, cyclicality and other factors. Seasonal changes are changes that can repeat with a season, for example an increase of in-person customer visits to the financial institution during the summer and an increase in remote activity during at the financial institution during the winter. Cyclicality is changes that occur at regular intervals, for example an increase of customer interactions at the financial institution each year during tax season or at Christmas. Other factors can include features than can independently impact a pattern of customer interactions, such as demographics and a portfolio mix. The customer interaction processing module 112 factors in non-linear elements of the pattern such as the amplitude and frequency of cyclicality.

The example data modeling module 204 uses a data model to extract components from the aggregated data that can lead to a better interpretation of the aggregated data than just using a linear regression of the aggregated data points. The components may be hidden from view but can be identified and extracted from the aggregated data using the data model. For the example system 100, the data model used is the unobserved components model. The example components extracted from the aggregated data using the unobserved components model include a trend, an amplitude and frequency of a cyclicality, a seasonality and a factor for dampening.

The components can help provide a more accurate analysis of changes in the data overtime than just a linear regression analysis of the overall data points. For example, the trend is a slope of a linear regression of the data points that does not include the effects of cyclicality, seasonality and other factors. The trend can smooth out spikes in the aggregated data that can be caused by the cyclicality, the seasonality and the other factors. The components of the unobserved data model are described in more detail later herein.

The example data analysis module 206 analyzes each category of the aggregated data to identify deviations over time in the aggregated data that can indicate an issue with the customer's relationship with the financial institution. The deviations are based on comparisons of an actual value of aggregated data with a predicted value of aggregated data based on the unobserved components model. When a deviation between an actual aggregated data value and a predicted aggregated data value for a data category at a specific time period is greater than a threshold value, the data analysis module 206 can flag the category of aggregated data for the data category as a customer issue that may need attention. As a result, the financial institution can take one or more actions, such as contacting the customer by telephone or email, arranging a personal meeting with the customer, performing an analysis of the customer's accounts at the financial institution to determine behavior that deviates from normal for the customer, or other actions. As an example of behavior that can indicate a deviation from normal for the customer can be an unusual number of withdrawals or withdrawals of a high dollar value from a customer account at the financial institution, closing a customer account, determining that the customer issued one more complaints against the financial institution, discovering that the customer is unemployed, etc.

The data analysis module 206 can also attempt to validate the data model by validating a correctness of predictions made by the model. For example, when the data analysis module 206 determines that there is a deviation in the aggregated data for a customer category that is above a threshold value, the customer interaction processing module 112 can check records of the financial institution to determine whether there are any identifiable changes in customer behavior that can be correlated with the deviation in the aggregated data. For example, when the aggregated data shows that the customer has made large withdrawals from the customer's account or closed the account and the customer interaction processing module 112 determines that the customer has issued a complaint against the financial institution, the issuance of a complaint can be correlated with the closing of an account or the withdrawal of large sums of money from the account. When the data analysis module 206 detects the same type of deviations in an aggregated data category for another customer, if it turns out that this customer has also lodged a complaint against the financial institution, this correlation can help to validate the data model. Other examples of validating the data model are possible.

The example self-correction module 208 can be used to automatically adjust operation of the data model to achieve more accurate results. The adjustment can comprise changing data model parameters that provide estimates of the hidden data components such as trend, cyclicality and seasonality. The adjustment can also comprise automatically adjusting the threshold value. The adjustment can be initiated when a determination is made that predictions made by the data model are not sufficiently accurate and that changes need to be made to the data model. In an example implementation, one or more learning algorithms can be used to self-correct the data model by refining components in the model, adding additional components, etc.

The unobserved components model, as used in this disclosure, comprises data components of trend, cyclicality, seasonality and a factor for dampening. Trend refers to a general movement, either up or down, of a customer's interactions over time, filtering out the impact of cycles, seasonality and independent factors. Seasonality refers to a pattern that repeats with the season, for example a relative increase in visits to the financial institution in the summer and a relative increase in online visits to the financial institution during the winter. Cyclicality refers to changes in customer interactions that appear at regular intervals, for example an increase in visits to the financial institution during tax season. Independent factors refer to features that can independently impact a pattern of customer interactions, such as demographics and portfolio mix. As used in this disclosure, the factor for dampening comprises the independent factors of the unobserved components model.

As stated earlier herein, the unobserved components model can be used to predict a future value of aggregated data for each of the categories for which aggregated data is compiled. The future value is based on applying the unobserved components model to aggregated data obtained and stored over a specific time period. In one example implementation, a time period of three years is used. In other example implementations, different time periods can be used, for example two years. The unobserved components model can be applied to the stored aggregated data to obtain a predicted value of aggregated data for a specific time in the future using the following equation (1):

Yₜ=Tₜ+CAₜ+CFₜ+Sₜ+Iₜ (1)

where:

Yₜ is a predicted aggregated data value at a time t

Tₜ is a value of the trend at the time t (e.g. 200+4.0*t)

CAₜ is a value of the amplitude of the cyclicality (peak of each cycle) at the time t (e.g. Cos(0.45*t)

CFₜ is a value of the frequency of the cyclicality (cycles per period) at the time t (e.g. 3*t)

Sₜ is a value of the seasonality at the time t (e.g. 25 for summer months, 35 for spring months, 15 for winter months and 10 for fall months)

Iₜ is a value of a dampening factor at the time t, where there can be multiple coefficients for each dampening factor (e.g. 30*t*an exogenous factor)

When the unobserved components model is applied to the stored aggregated data for an data category, Yₜ represents the predicted aggregated data value at a time t. The value Yₜ can be compared to an actual aggregated data value at the time t and a deviation between the actual aggregated data value and the predicted data value can be measured. When the deviation is greater that the threshold for the aggregated data category, a potential customer issue can be identified.

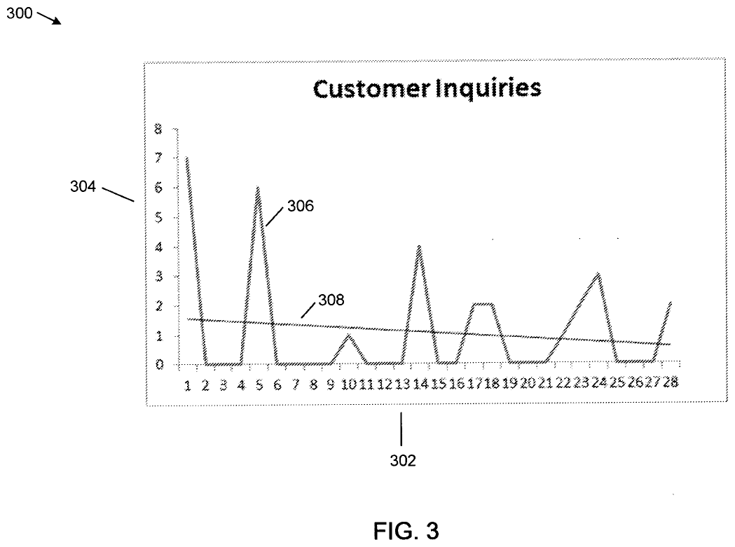

FIG. 3 shows an example graph 300 of customer inquiries over a 30 month period. Each month of the 30 month period is shown in the x axis 302 and a number of customer inquiries corresponding to each month is shown on the y axis 304. For the graph 300, the number of customer inquiries for each month is represented by the line 306. As shown, the line 306 includes cyclical data, as indicated by periodic peaks in line 306. In addition, line 306 can also include seasonality values.

FIG. 3 also shows an example trend line 308 which shows a trend in the aggregated values over the 30 month period. The trend represents a direction of the aggregated data values that does not takes into account the cyclical, seasonal and dampening factors. The trend is obtained from an analysis of the aggregated data values by the unobserved components model. Components such as the trend, the amplitude and frequency of the cyclicality, the seasonality and the dampening are hidden components and can be extracted from the aggregated data using the unobserved components model.

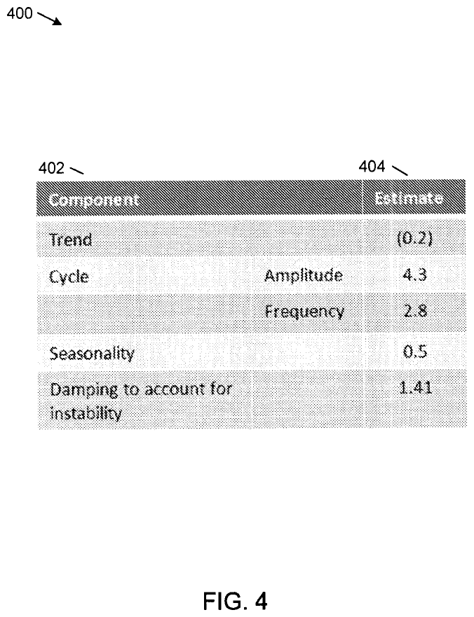

FIG. 4 shows an example table 400 of component values for the graph 300 as extracted from the aggregated data using the unobserved components model. The table 400 includes columns to component 402 and an estimated value of the component 404. As shown, in FIG. 4 as determined by an evaluation of aggregated data values for the graph 300, the trend is estimated to be 0.2, the amplitude of the cycle is estimated to be 4.3, the frequency of the cycle is estimated to be 0.5 and the dampening factor is estimated to be 1.41. Using these example estimated values in conjunction with equation (1), the customer interaction processing module 112 can calculate a predicted aggregated value Yₜ for a specific time period, for example three months from the 30 month time period of FIG. 3, compare Yₜ to an actual value of the aggregated data value at the specific time period and determine a deviation.

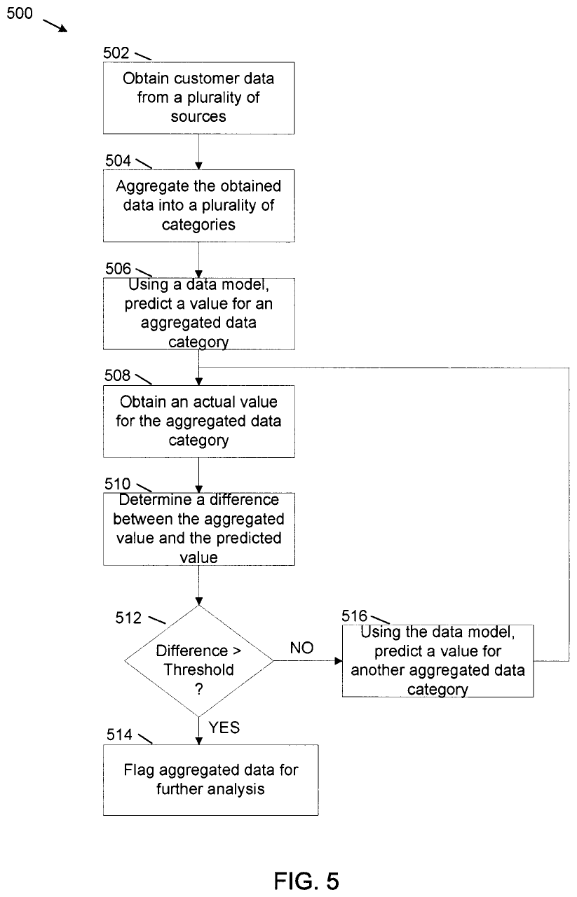

FIG. 5 shows a flowchart of an example method 500 for automatically analyzing data regarding customer interactions with a financial institution and determining whether the data suggests any imminent changes of customer behavior at the financial institution.

At operation 502, customer data is obtained from a plurality sources. The customer data comprises records of customer interactions with the financial institution. The plurality of sources can comprise client computers, laptop computers, desktop computers, mobile computing devices such as smartphones and records made of direct customer interactions with the financial institution.

At operation 504, the customer interaction data is aggregated into a plurality of categories. For the implementation of method 500, the customer interaction data is aggregated into six categories comprising deposits, relationship maintenance, in-person withdrawals, remote withdrawals, in-person activity and remote activity, as discussed earlier herein.

At operation 506, a data model is used to predict a value for an aggregated data category. For the implementation of method 500, the unobserved components model is used. The unobserved components model can extract hidden values from the aggregated data, including a trend, an amplitude and frequency of cyclicality, a seasonality and a damping factor, as discussed earlier herein. Using an equation similar to equation (1) above, the unobserved components model can predict a value of the aggregated data for a category of aggregated data at a time t in the future, as explained earlier herein.

At operation 508, an actual value of the aggregated data is obtained for the category of aggregated data of operation 506 at the time t. The aggregation module 202 can aggregate data value for the category from data values for the category obtained from one or more of the organization computer systems 106 at the time t.

At operation 510, a difference is determined between the value of the aggregated data value and the actual data value. For method 500, the difference is calculated to be a percentage to which the actual data value is greater than or less than the actual data value.

At operation 512, a determination is made as to whether the difference between the value of the aggregated data value and the actual data value is greater than a threshold. For method 500, the threshold is a percentage, for example 20%. The threshold can be different for each of the categories of aggregated data. For example, for some categories of aggregated data the threshold can be 15%, for some other categories the threshold can be 10%. Other values for the threshold can be used.

At operation 512, when a determination is made that the difference between the actual value of the aggregated data and the predicted value of the aggregated data is greater than the threshold, at operation 514, the aggregated data is flagged for further analysis. This can mean, for example, having a financial institution employee, review account data for the customer and determine if any additional actions should be taken. Examples of additional actions can be calling or emailing the customer to determine if the customer has any issues with the financial institution, arranging for the customer to meet personally with an employee of the financial institution, sending a letter to the customer, offering the customer rewards or promotions or other actions.

At operation 512, when a determination is made that the difference between the actual value of the aggregated data and the predicted value of the aggregated data is not greater than the threshold, at operation 516, the unobserved components model is used to predict a value for another aggregated data category at the time t. Control then returns to operation 506 where an actual value for the another aggregated data category is obtained at the time t. Operations 510, 512 and 514 or 516 are repeated for each remaining aggregated data category.

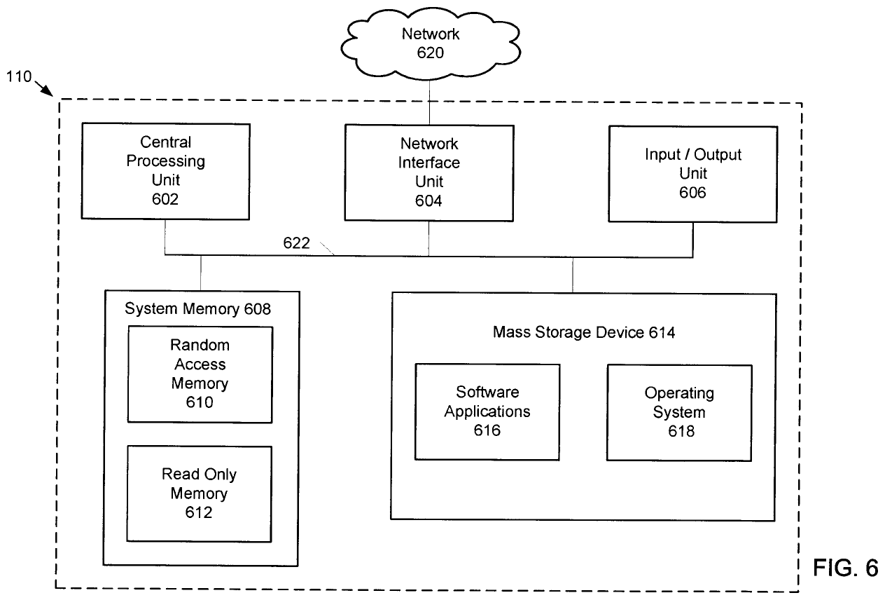

As illustrated in the example of FIG. 6, server computer 110 includes at least one central processing unit (“CPU”) 602, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the server computer 110, such as during startup, is stored in the ROM 612. The server computer 110 further includes a mass storage device 614. The mass storage device 614 is able to store software instructions and data.

The mass storage device 614 is connected to the CPU 602 through a mass storage controller (not shown) connected to the system bus 622. The mass storage device 614 and its associated computer-readable data storage media provide non-volatile, non-transitory storage for the server computer 110. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 110.

According to various embodiments of the invention, the server computer 110 may operate in a networked environment using logical connections to remote network devices through the network 620, such as a wireless network, the Internet, or another type of network. The server computer 110 may connect to the network 620 through a network interface unit 604 connected to the system bus 622. It should be appreciated that the network interface unit 604 may also be utilized to connect to other types of networks and remote computing systems. The server computer 110 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the server computer 110 can store software instructions and data. The software instructions include an operating system 618 suitable for controlling the operation of the server computer 110. The mass storage device 614 and/or the RAM 610 also store software instructions, that when executed by the CPU 602, cause the server computer 110 to provide the functionality of the server computer 110 discussed in this document. For example, the mass storage device 614 and/or the RAM 610 can store software instructions that, when executed by the CPU 602, cause the server computer 110 to display received data on the display screen of the server computer 110.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer-implemented method for analyzing interactions of a customer with an organization, the method comprising:
obtaining data regarding interactions of the customer with the organization, the data being obtained from a plurality of sources;
aggregating the data obtained into a plurality of categories, the plurality of categories including at least a first category of online transactions made by the customer and a second category of in-person transactions made by the customer;
developing a data model for the customer by:
accessing a plurality of previous customer interactions stored in a database; and
using the previous customer interactions to develop patterns;
wherein the data model is an unobserved components data model;
using the data model, predicting a value for aggregated data in the first category and the second category at a first time period in the future, wherein the data model uses cyclicality and seasonality to account for periodic anticipated changes of the data that is aggregated, trends to account for general anticipated changes of the data that is aggregated, independent of cyclicality and seasonality and a dampening factor to account for independent factors that impact a pattern of customer interactions including customer demographics and portfolio mix, to predict the value for the aggregated data in the first category and the second category;
obtaining an actual value for the aggregated data for the first category after the first time period has occurred;
determining whether a difference between the value predicted for the aggregated data for the first category and the second category and the actual value for the aggregated data for the first category and the second category exceeds a first threshold; and
when the difference between the value predicted for the aggregated data for the first category and the second category and the actual value for the aggregated data for the first category and the second category exceeds the first threshold, taking one or more actions regarding the customer, including arranging for the customer to meet with an employee of the organization.

2. The method of claim 1, wherein, when the difference between the value predicted for the aggregated data for the first category and the actual value for the aggregated data for the first category exceeds the first threshold, further comprising:
identifying a deviation from normal customer behavior for the first category based on the first threshold being exceeded; and
creating a data record indicating the deviation from normal customer behavior for the first category based on the first threshold being exceeded.

3. The method of claim 2, further comprising:
detecting when differences between predicted values of aggregated data and actual values of aggregated data exceeds the first threshold for one or more additional customers;
determining whether one or more of the one or more additional customers have similar deviations from normal behavior as indicated in the data record for the customer; and
when one or more additional customers have similar deviations from normal behavior as indicated in the data record for the customer, validating the data model.

4. The method of claim 3, wherein when a determination is made that the one or more additional customers do not have similar deviations from normal behavior as indicated in the data record for the customer, taking one or more self-correcting actions to modify operation of the data model.

5. The method of claim 3, wherein when a determination is made that one or more of the one or more additional customers have similar deviations from normal behavior as indicated in the data record for the customer, taking one or more corrective actions for the one or more additional customers that have similar deviations from normal behavior.

6. The method of claim 1, further comprising:
using the data model, predicting an aggregated data value for one or more additional categories at the first time period;
obtaining an actual aggregated data value for the one or more additional categories at the first time period;
determining whether a difference between the predicted aggregated data value for the one or more additional categories and the actual aggregated data value for the one or more additional categories exceeds one or more additional thresholds; and
when the difference between the predicted aggregated data value and the actual aggregated data value for the first category exceeds the one or more additional thresholds, taking one or more actions regarding the customer.

7. The method of claim 6, wherein one or more of the one or more additional thresholds can be different from each other and from the first threshold.

8. The method of claim 6, wherein the first threshold and the one or more additional thresholds is a percentage.

9. The method of claim 1, wherein the plurality of categories include one or more of deposits, relationship maintenance, in-person withdrawals, withdrawals other than in-person, in-person activity and remote activity.

10. The method of claim 1, wherein the data is aggregated on a household level.

11. (canceled)

12. The method of claim 1, wherein the data model uses data obtained over a multi-year period.

13. The method of claim 1, further comprising automatically adjusting the first threshold during a self-correction of the data model.

14. The method of claim 1, wherein when the difference between the actual value predicted for the aggregated data for the first category and the actual value for the aggregated data for the first category does not exceed the first threshold, further comprising:
obtaining actual values of aggregated data and predicted values of aggregated data for additional time periods;
determining whether a deviation between the actual values of aggregated data for the additional time periods and the predicted values of aggregated data for the additional time periods exceeds the first threshold; and
when at least one deviation between the actual values of aggregated data for the additional time periods and the predicted values of aggregated data for the additional time periods exceeds the first threshold, taking one or more actions regarding the customer.

15. An electronic computing device comprising:
a processing unit; and
system memory, the system memory including instructions which, when executed by the processing unit, cause the electronic computing device to:
obtain data regarding interactions of a customer household with a financial institution for a customer of the financial institution, the data being obtained from a plurality of sources;
aggregate the data obtained into a plurality of categories, the plurality of categories including at least a first category of online transactions made by the customer and a second category of in-person transactions made by the customer;
develop a data model for the customer by to:
access a plurality of previous customer interactions stored in a database; and
use the previous customer interactions to develop patterns;
use the data model to predict an aggregated data value in the first category at a first time period in the future;
obtain an actual value for aggregated data for the first category and the second category after the first time period has occurred, wherein the data model uses cyclicality and seasonality to account for periodic anticipated changes of the data that is aggregated, trends to account for general anticipated changes of the data that is aggregated, independent of cyclicality and seasonality and a dampening factor to account for independent factors that impact a pattern of customer interactions including customer demographics and portfolio mix, to predict the value for the aggregated data in the first category and the second category;
determine whether a difference between the predicted aggregated data value for the first category and the second category and the actual value for the aggregated data for the first category and the second category exceeds a first threshold; and
when the difference between the predicted aggregated data value for the first category and the second category and the actual value for the aggregated data for the first category and the second category exceeds the first threshold, take one or more actions regarding the customer, including arranging for the customer to meet with an employee of the organization.

16. The electronic computing device of claim 15, wherein when the difference between the value predicted for the aggregated data for the first category and the actual value for the aggregated data for the first category exceeds the first threshold, further comprising:
determine whether the customer deviated from normal behavior during a time period before the actual value for the aggregated data for the first category is obtained; and
when a determination is made that the customer deviated from normal behavior, create a data record indicating a specific change in behavior for the customer and the first category for which the first threshold is detected.

17. The electronic computing device of claim 16, wherein when a determination is made that one or more additional customers have similar deviations from normal behavior as indicated in the data record for the customer, take one or more corrective actions for the one or more additional customers that have similar deviations from normal behavior.

18. The electronic computing device of claim 17, wherein when a determination is made that the one or more additional customers do not have similar deviations from normal behavior as indicated in the data record for the customer, take one or more self-correcting actions to modify operation of the data model.

19. The electronic computing device of claim 15, wherein the plurality of categories include one or more of deposits, relationship maintenance, in-person withdrawals, withdrawals other than in-person, in-person activity and remote activity.

20. An electronic computing device comprising:
a processing unit; and
system memory, the system memory including instructions which, when executed by the processing unit, cause the electronic computing device to:
obtain data regarding interactions of a customer household with a financial institution for a customer of the financial institution, the data being obtained from a plurality of sources, the data regarding the customer household encompassing a multi-year period;
aggregate the data obtained into a plurality of categories, the plurality of categories including one or more of deposits made by the customer, relationship maintenance for the customer, in-person withdrawals made by the customer, withdrawals other than in-person made by the customer, in-person activity and remote activity by the customer, the plurality of categories including at least a first category of online transactions and a second category of in-person transactions;
develop a data model for the customer by to:
access a plurality of previous customer interactions stored in a database; and
use the previous customer interactions to develop patterns;
use the data model to predict a value for aggregated data in the first category at a first time period in the future, the data model using a trend, a cyclicality, a seasonality and a dampening factor of the data that is aggregated to predict the aggregated data in the first category;
obtain an actual value for aggregated data for the first category and the second category after the first time period has occurred, wherein the data model uses cyclicality and seasonality to account for periodic anticipated changes of the data that is aggregated, trends to account for general anticipated changes of the data that is aggregated, independent of cyclicality and seasonality, and the dampening factor to account for independent factors that impact a pattern of customer interactions including customer demographics and portfolio mix to predict the value for the aggregated data in the first category and the second category;
to predict the value for the aggregated data in the first category and the second category;
determine whether a difference between the value predicted for the aggregated data for the first category and the second category and the actual value for the aggregated data for the first category and the second category exceeds a first threshold, the first threshold being a percentage; and
when the difference between the value predicted for the aggregated data for the first category and the second category and the actual value for the aggregated data for the first category and the second category exceeds the first threshold, take one or more actions regarding the customer;
using the data model, predict a value for aggregated data for one or more additional categories at the first time period;
obtain the actual value for aggregated data for the one or more additional categories at the first time period;
determine whether a difference between the value predicted for the aggregated data for the one or more additional categories and the actual value for the aggregated data for the one or more additional categories exceeds one or more additional thresholds; and
when the difference between the value predicted for the aggregated data for the one or more additional categories and the actual value for the aggregated data for the first category exceeds the one or more additional thresholds, take one or more actions regarding the customer, including arranging for the customer to meet with an employee of the organization, and wherein the one or more additional thresholds can be different for each of the one or more additional categories and different from the first threshold.
